(19) United States
(12) Patent Application Publication
(10) Pub. No.: US 2015/0207551 A1
(43) Pub. Date: Jul. 23, 2015

(54) SPATIAL MODULATION METHOD USING POLARIZATION AND APPARATUS USING THE SAME

(71) Applicant: ELECTRONICS AND TELECOMMUNICATIONS RESEARCH INSTITUTE, Daejeon (KR)

(72) Inventors: Min Soo KANG, Daejeon (KR); Kwang Seon KIM, Daejeon (KR); Bong Su KIM, Daejeon (KR); Woo Jin BYUN, Daejeon (KR); Jong Soo LIM, Daejeon (KR); Myung Sun SONG, Daejeon (KR); Jae Ick CHOI, Daejeon (KR)

(21) Appl. No.: 14/327,750

(22) Filed: Jul. 10, 2014

(30) Foreign Application Priority Data
Jan. 23, 2014 (KR) 10-2014-0008078

(51) Int. Cl. H04B 7/04; H04B 7/08; H04L 25/02; H04B 7/06

(52) U.S. Cl. CPC H04B 7/0469; H04B 7/0608; H04B 7/0888; H04L 25/0204

(57) ABSTRACT

A spatial modulation method using a polarization and an apparatus using the same are provided. A spatial modulation method by a transmitting apparatus in a wireless communication system may comprise selecting an antenna to send data among transmit antennas arranged to have different polarization angles using a predetermined bit of input data based on indexes of the transmit antenna and mapping remaining bits of the input data to a preset constellation and transmitting the remaining bits of the mapped input data through the selected antenna.

Priority to Korean patent application number 2014-0008078 filed on Jan. 23, 2014, the entire disclosure of which is incorporated by reference herein, is claimed.

### BACKGROUND OF THE INVENTION

1. Technical Field

Embodiments of the present invention concern a method of performing spatial modulation using a polarization in a wireless communication system and an apparatus using the same.

2. Discussion of Related Art

Appearance of smartphones and spreading LTE (Long Term Evolution) systems led to a rapid growth of data usage, and to address such issue, OFDM (Orthogonal Frequency Division Multiplexing), MIMO (Multi-Input Multi-Output) or other techniques for efficiently utilizing frequency resources are being developed. In particular, MIMO technique enables more data transmission with the same frequency and channel space, and thus, is underway for intensive research. However, the MIMO technique requires a complicated channel algorithm for reducing distortion that may occur due to a multi-path and a proper antenna arrangement for increasing capacity gain.

As a scheme for addressing the complexity of MIMO technique, Korean Patent Application Publication No. 10-2008-0006148 (published on Jan. 16, 2008), titled “spatial modulation method in multi-input/output system and transmitting/receiving apparatus using the same,” discloses a spatial modulation technique that allows for additional data transmission by operating only one of several transmit antennas at a certain time and detecting the same at the receiving end. Further, unlike a complicated channel estimation algorithm (V-BLAST) in an MIMO technique using multi-path fading in an existing cellular environment, a method is disclosed of configuring a system utilizing a simpler channel estimation algorithm (i-MRC: iterative Maximum Ratio Combining).

In this technique, specifically, when data containing a number of bit information is input to a spatial modulating unit 110, the data is split into an antenna bit block and a signal modulation block using a splitting unit 111 as shown in FIG. 1. The split data are respectively applied to an antenna index encoding unit 112 and a signal modulation encoding unit 113 and are then mapped with a signal modulation constellation to be then transmitted via one activated at a unit time determined by the antenna index encoding unit 112 among a number of transmit antennas 120. The signal sent through one antenna goes through a radio channel path ([H]) and is then received by the receive antennas 130, and an i-MRC algorithm-applied detecting unit 140 estimates an antenna index from the received signal, and the spatial modulating unit 150 combines the antenna index estimated by the detecting unit 140 with the received signal, outputting data.

However, such prior art may raise per-hertz transmission efficiency as compared with existing MIMO systems using information on the spatial arrangement of antennas but is difficult to utilize under the environment with little change in radio channel environments. Further, the prior art is less complicated than the MIMO system, but requires a complicated reception algorithm to discover a radio channel environment.

### SUMMARY OF THE INVENTION

An object of the present invention is to provide a spatial modulation method using a polarization that may be also applicable to a radio channel environment such as LOS (Line of Sight) or NLOS (Non Line of Sight) and an apparatus using the same.

Another object of the present invention is to provide a spatial modulation method using a polarization that may simply detect a transmit antenna even with no complicated reception algorithm and an apparatus using the same.

Still another object of the present invention is to provide a spatial modulation method using a polarization that may simplify a spatial arrangement of antennas and an apparatus using the same.

According to an aspect of the present invention, a spatial modulation method by a transmitting apparatus in a wireless communication system may comprise selecting an antenna to send data among transmit antennas arranged to have different polarization angles using a predetermined bit of input data based on indexes of the transmit antenna and mapping remaining bits of the input data to a preset constellation and transmitting the remaining bits of the mapped input data through the selected antenna.

In an aspect, the selected antenna may be estimated by comparing the magnitude of power detected from each of signals received through receive antennas arranged to have different polarization angles, and wherein the input data may be demodulated based on information on the estimated antenna.

In another aspect, transmitting the remaining bits may include transmitting the remaining bits of the mapped input data through a vertical polarization or a horizontal polarization of the selected antenna using an ortho-mode transducer.

In still another aspect, the transmit antennas may be orthogonal mode antennas arranged to have 45-degree different polarization angles.

In yet still another aspect, the transmit antennas may be arranged to have polarization angles of 0, 45, 90, and 135 degrees, respectively.

According to another aspect of the present invention, a transmitting apparatus in a wireless communication system may comprise a plurality of transmit antennas arranged to have different polarization angles and a spatial modulating unit selecting an antenna to send data among the plurality of transmit antennas using a predetermined bit of input data based on indexes of the transmit antennas and mapping remaining bits of the input data to a preset constellation.

According to another aspect of the present invention, a method of demodulating spatial modulated data in a wireless communication system may comprise receiving signals through a plurality of receive antennas arranged to have different polarization angles, detecting power of each of the received signals, estimating a transmit antenna that has sent a signal by comparing the magnitude of the detected power, and demodulating the signal based on information on the estimated transmit antenna.

According to another aspect of the present invention, a receiving apparatus in a wireless communication system may comprise a plurality of receive antennas arranged to have different polarization angles, a power detector detecting power of signals received through the receive antennas, and a spatial demodulating unit comparing the magnitude of the detected power to estimate a transmit antenna that has sent the signal and demodulating the signal based on information on the estimated transmit antenna.

Regardless of radio channel environments, spatial modulation is possible by a polarization of an antenna, and it may also be applicable to a radio channel environment such as LOS (Line of Sight) or NLOS (Non Line of Sight).

An antenna for spatial modulation is configured using orthogonality between polarization modes, and thus, a transmit antenna may be detected by mere power detection, thus allowing for a simpler, cheaper receiver architecture.

The number of antennas may be reduced by utilizing a polarization, thus simplifying a spatial arrangement of antennas.

### BRIEF DESCRIPTION OF DRAWINGS

FIG. 1 is a view illustrating a spatial modulation method using an existing channel estimation algorithm;

FIG. 2 is a flowchart illustrating a method of spatial modulating input data using a polarization and demodulating the spatial modulated signal according to an embodiment of the present invention;

FIG. 3 is a view illustrating the operation principle of a 4×4 spatial modulation scheme according to an embodiment of the present invention;

FIG. 4 is a view illustrating a method of extracting a transmission signal according to an embodiment of the present invention; and

FIGS. 5 and 6 are views illustrating spatial modulating systems according to embodiments of the present invention.

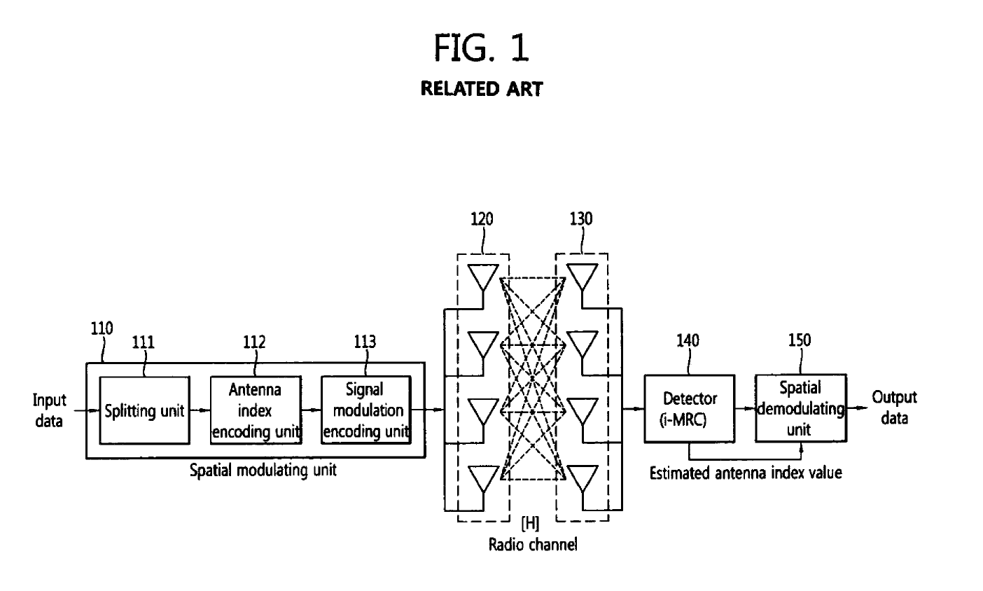

### DETAILED DESCRIPTION OF EMBODIMENTS

Hereinafter, embodiments of the present invention are described below in detail with reference to the accompanying drawings so that the embodiments can be easily practiced by one of ordinary skill in the art. However, various changes may be made without being limited thereto. What is irrelevant to the present invention was skipped from the description for clarity, and like reference denotations are used to refer to like or similar elements throughout the specification.

As used herein, when an element “includes” another element, the element may further have the other element unless stated otherwise. As used herein, the term “unit” denotes a unit of performing at least one function or operation and may be implemented in hardware, software, or a combination thereof.

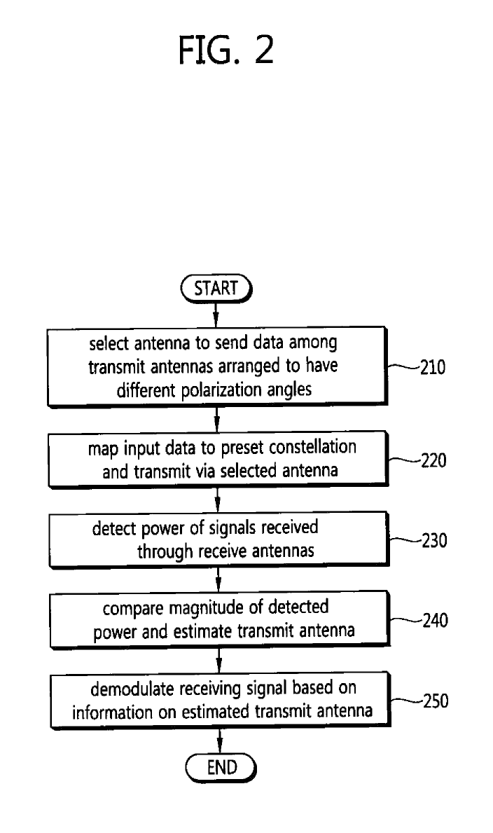

FIG. 2 is a flowchart illustrating a method of spatial modulating input data using a polarization and demodulating the spatial modulated signal.

Referring to FIG. 2, in a spatial modulation system according to the present invention, the transmitting apparatus selects an antenna to send data among transmit antennas arranged to have different polarization angles using part of input data for spatial modulation (step 210). At this time, the transmitting apparatus may activate only one transmit antenna at a unit time. The remainder of the input data is mapped with a predetermined constellation and is transmitted via the selected antenna (step 220).

As an example, the transmitting apparatus may select an antenna to send data among the transmit antennas using a predetermined bit of input data based on the indexes of the transmit antennas, map the remaining bits of the input data to a QPSK (Quadrature Phase Shift Keying) constellation, and then send through the selected antenna, thereby spatial-modulating the input data. At this time, each transmit antenna may be connected with an OMT (Ortho-Mode Transducer) that combines or splits a vertical polarization and a horizontal polarization, and in such case, the transmitting apparatus may send the remaining bits of the input data mapped with the QPSK constellation through the vertical polarization or horizontal polarization of the selected antenna using the OMT.

Meanwhile, the transmit antennas may be orthogonal mode antennas arranged to have polarization angles different by 45 degrees with respect to each other. The orthogonal mode antennas may have a function of an OMT. As such, in case the transmitting apparatus and the receiving apparatus have antennas with different polarization angles and the antennas are connected to an OMT or each have an orthogonal mode antenna, 4×4 MIMO (Multi-Input Multi-Output) may be implemented only with two transmit antennas, simplifying the spatial arrangement of antennas. Further, for such purpose, the transmitting apparatus and the receiving apparatus each may have antennas arranged to have polarization angles of 0, 45, 90, and 135 degrees.

An antenna selected by the transmitting apparatus may be estimated by comparing the magnitude of power detected from each of the signals received through the receive antennas arranged to have different polarization angles. Accordingly, the receiving apparatus according to the present invention detects power of the signals received through the receive antennas (step 230) and compares the magnitude of the detected power to thus estimate the transmit antenna (step 240). When the transmit antenna is estimated, the receiving apparatus may demodulate the received signal based on the information on the estimated antenna.

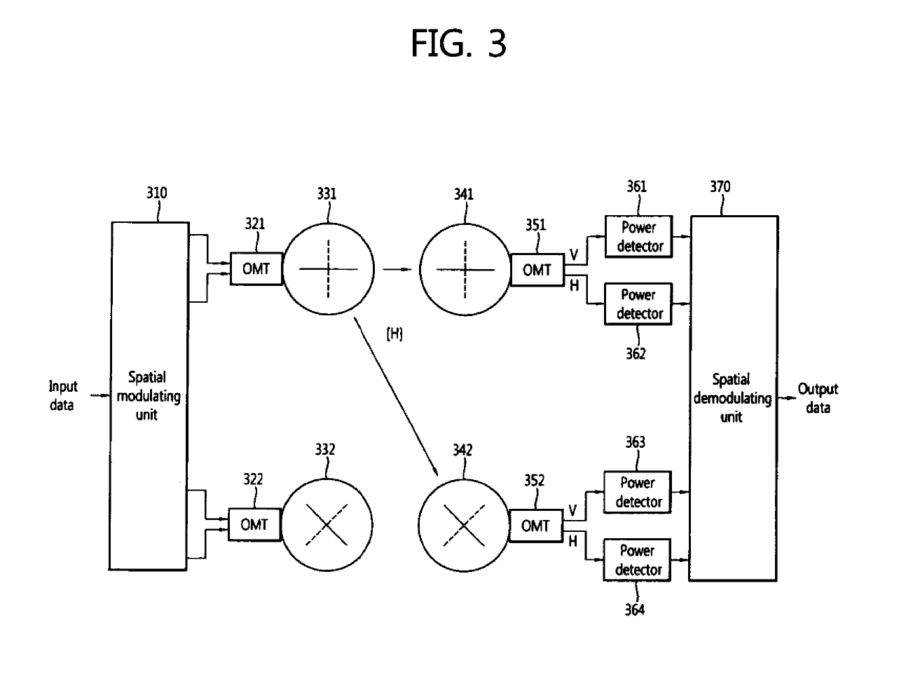

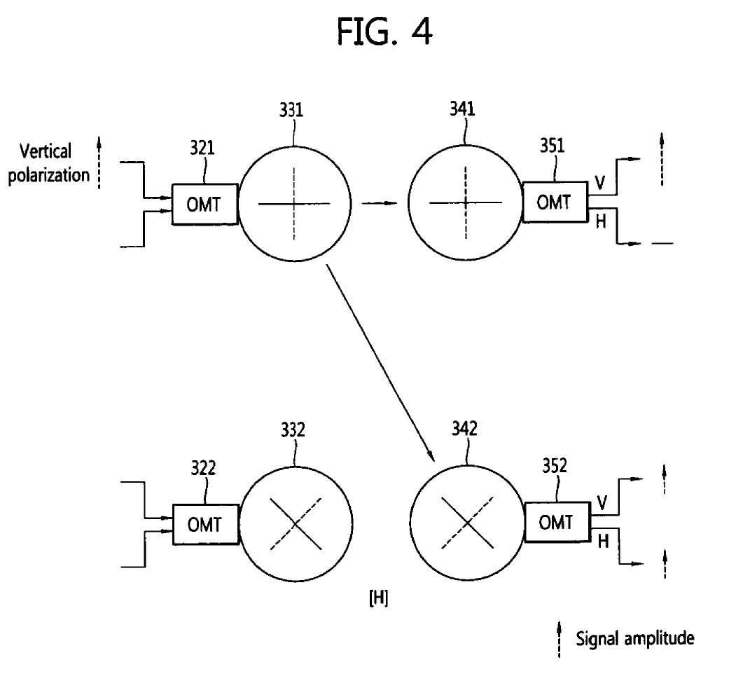

FIG. 3 is a view illustrating the operation principle of a 4×4 spatial modulation scheme according to an embodiment of the present invention, and FIG. 4 is a view illustrating a method of extracting a transmission signal according to an embodiment of the present invention.

Hereinafter, the operation principle of a 4×4 spatial modulation scheme according to the present invention is described in greater detail. The dotted-line arrow shown in each antenna 331, 332, 341, and 342 indicates a vertical polarization (V: Vertical), and the solid-line arrow indicates a horizontal polarization (H: Horizontal). The vertical polarization is orthogonal to the horizontal polarization. [H] refers to a channel function matrix between transmit antennas 331 and 332 and receive antennas 341 and 342, and OMTs (Ortho-Mode Transducers) 321, 322, 351, and 352 are elements to combine or split the vertical polarization and the horizontal polarization.

For brevity of description, a communication scheme employing four data in a set is described. The spatial modulating unit 310 may separate input data into an antenna bit and an information bit. Accordingly, the most and second most significant bits of the input data applied to the spatial modulating unit 310 are used as bits to select an antenna, are mapped with a specific antenna, and the least and second least significant bits may be mapped with a QPSK-modulation constellation. By way of example, the transmission signal is transmitted through a specific polarization (vertical or horizontal) of a particular antenna, after mapped. For example, as shown in FIG. 3, in case a first transmit antenna 331 and the vertical polarization mode are selected by the most and second most significant bits, signals are transmitted only in vertical polarization mode of the first transmit antenna 331 at a certain time. The transmitted signal is simultaneously received by the first receive antenna 341 and the second receive antenna 342 via a radio channel path [H]. Such signals are split into vertical and horizontal polarization paths through the OMTs 351 and 352 respectively connected with the first receive antenna 341 and the second receive antenna 342, and the power detectors 361, 362, 363, and 364 detect power from the split signals and extract received size information. The spatial demodulating unit 370 compares the received size information extracted from the power detectors 361, 362, 363, and 364 to detect the antenna from which the signal has been transmitted and the polarization mode and accordingly assigns two receiving bits, compares with two bits demodulated through QPSK demodulation to thus demodulate four bits that intend to be originally restored.

Hereinafter, a method of extracting a transmission signal by the receiving apparatus is described in greater detail with reference to FIG. 4. Signals transmitted in vertical polarization mode of the first transmit antenna 331 are received by the receive antennas 341 and 342 via a radio channel path [H]. The signals applied to the receive antennas 341 and 342, respectively, are polarization-split through their respective OMTs 351 and 352. In such case, since signals have been transmitted in vertical polarization mode of the first transmit antenna 331, a signal of the maximum size is received via the vertical polarization path of the first receive antenna 341 while a signal having the degree of a noise level is received via the horizontal polarization path of the first receive antenna 341 due to orthogonality. Further, since the second receive antenna 342 has a polarization direction arranged in the slope of 45 degrees with respect to the first transmit antenna 331, a signal of a smaller amplitude is received via the vertical polarization path and the horizontal polarization path as compared with the signal received via the vertical polarization path of the first receive antenna 341. In this case, since the polarization slope between the vertical polarization of the first transmit antenna 331 and the vertical and horizontal polarizations of the second receive antenna 342 is constant as 45 degrees, signals of the same amplitude are received via the vertical polarization path and the horizontal polarization path of the second receive antenna 342. This is why the horizontal polarization and the vertical polarization have the same radio channel path. According to the present invention, the receiving apparatus may easily determine a transmit antenna by simply detecting the power of a signal received through each path even without a separate algorithm using such characteristics.

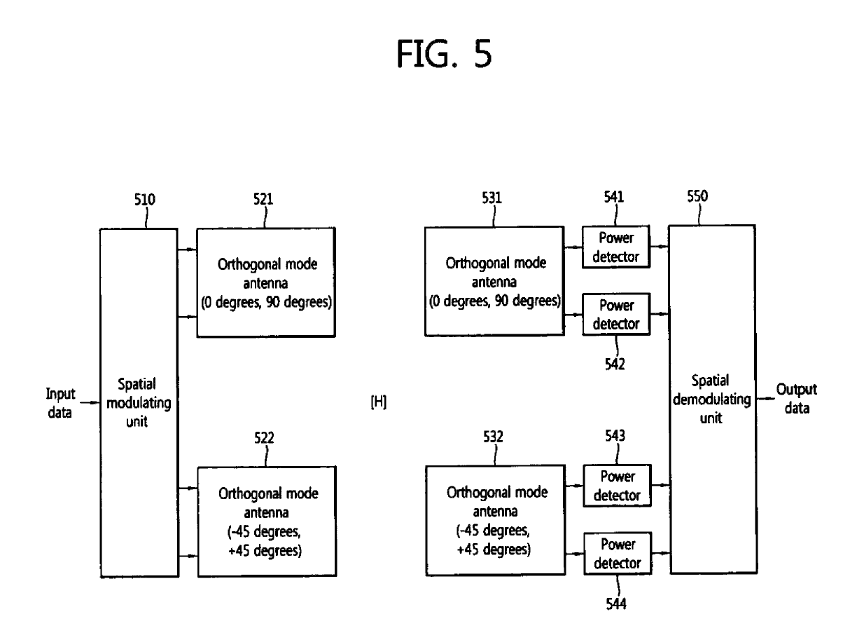

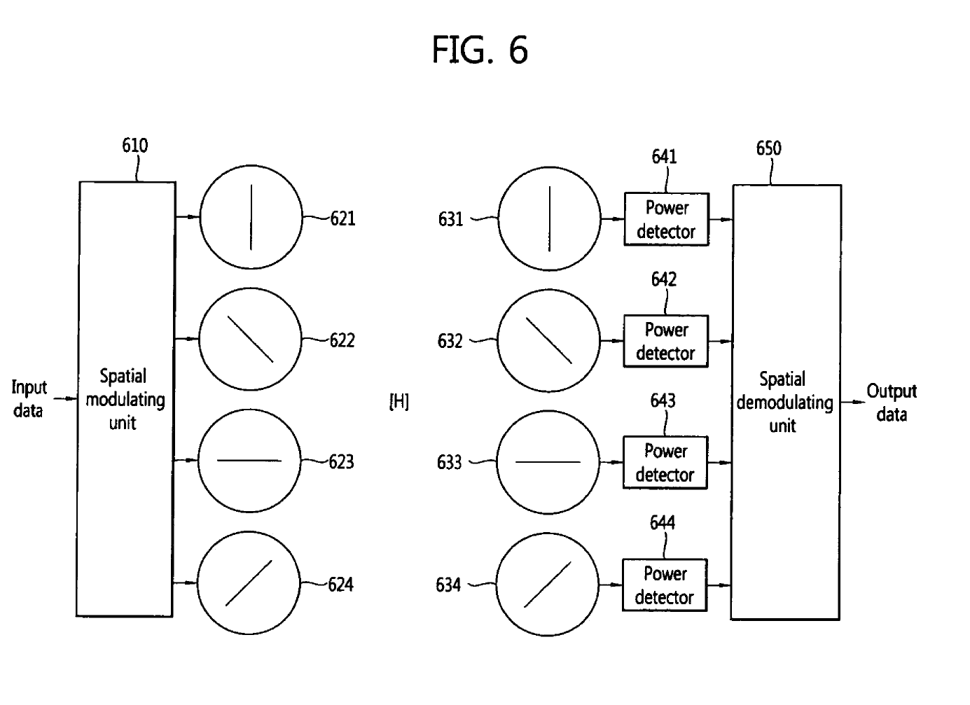

FIGS. 5 and 6 are views illustrating spatial modulating systems according to embodiments of the present invention.

A spatial modulating system according to the present invention includes a transmitting apparatus and a receiving apparatus. The transmitting apparatus includes a plurality of transmit antennas arranged to have different polarization angles as shown in FIGS. 3, 5, and 6, and a spatial modulating unit that selects an antenna to send data among the plurality of transmit antennas using a predetermined bit of input data based on indexes of the transmit antennas and that maps the remaining bits of the input data to a preset constellation. The receiving apparatus includes a plurality of receive antennas arranged to have different polarization angles, a power detector detecting the power of a signal received through the receive antennas, and a spatial demodulating unit that compares the detected power to estimate the transmit antenna that has send the signal and that demodulates the signal based on information on the estimated transmit antenna.

The receiving apparatus and the transmitting apparatus each may include an OMT for combining or splitting a vertical polarization and a horizontal polarization as shown in FIG. 3. In such case, the transmitting apparatus may send signals through the vertical polarization and horizontal polarization using the OMT, and the receiving apparatus may split the received signal into a vertical polarization path or horizontal polarization path using the OMT.

In another embodiment, the receiving apparatus and the transmitting apparatus according to the present invention may replace the antenna shown in FIG. 3 with an orthogonal mode antenna including the function of an OMT as shown in FIG. 5. In such case, the orthogonal mode antennas may be arranged to have 45-degree different polarization angles from each other with respect to each of the transmitting apparatus and the receiving apparatus.

Further, the receiving apparatus and the transmitting apparatus according to the present invention may have the antennas arranged to have polarization angles of 0, 45, 90, and 135 degrees with no element for mode splitting or combination as shown in FIG. 6, thus configuring a spatial modulating system in an LOS environment.

Although the present invention has been shown and described with reference to embodiments thereof, it will be understood by one of ordinary skill in the art that various changes in form and detail may be made thereto without departing from the scope of the present invention defined by the following claims.

1. A spatial modulation method by a transmitting apparatus in a wireless communication system, the spatial modulation method comprising:
selecting an antenna to send data among transmit antennas arranged to have different polarization angles using a predetermined bit of input data based on indexes of the transmit antenna and mapping remaining bits of the input data to a preset constellation; and
transmitting the remaining bits of the mapped input data through the selected antenna,
wherein the selected antenna is estimated by comparing the magnitude of power detected from each of signals received through receive antennas arranged to have different polarization angles, and wherein the input data is demodulated based on information on the estimated antenna.

2. (canceled)

3. The spatial modulation method of claim 1, wherein transmitting the remaining bits includes transmitting the remaining bits of the mapped input data through a vertical polarization or a horizontal polarization of the selected antenna using an ortho-mode transducer.

4. The spatial modulation method of claim 1, wherein the transmit antennas are orthogonal mode antennas arranged to have 45-degree different polarization angles.

5. The spatial modulation method of claim 1, wherein the transmit antennas are arranged to have polarization angles of 0, 45, 90, and 135 degrees, respectively.

6. A transmitting apparatus in a wireless communication system, the transmitting apparatus comprising:
a plurality of transmit antennas arranged to have different polarization angles;
a spatial modulating unit selecting an antenna to send data among the plurality of transmit antennas using a predetermined bit of input data based on indexes of the transmit antennas and mapping remaining bits of the input data to a preset constellation,
wherein the selected antenna is estimated by comparing the magnitude of power detected from each of signals received through receive antennas arranged to have different polarization angles.

7. (canceled)

8. The transmitting apparatus of claim 6, further comprising an ortho-mode transducer for transmitting the remaining bits of the mapped input data through a vertical polarization or a horizontal polarization of the selected antenna.

9. The transmitting apparatus of claim 6, wherein the transmit antennas are orthogonal mode antennas arranged to have 45-degree different polarization angles.

10. The transmitting apparatus of claim 6, wherein the transmit antennas are arranged to have polarization angles of 0, 45, 90, and 135 degrees, respectively.

11. A method of demodulating, spatial modulated data in a wireless communication system, the method comprising:
receiving signals through a plurality of receive antennas arranged to have different polarization angles;
detecting power of each of the received signals;
estimating a transmit antenna that has sent a signal by comparing the magnitude of the detected power; and
demodulating the signal based on information on the estimated transmit antenna,
wherein the received signal is transmitted through an antenna selected using a predetermined bit of input data based on indexes of the transmit antennas arranged to have different polarization angles.

12. (canceled)

13. The method of claim 11, wherein the received signal is split into a vertical polarization path and a horizontal polarization path through an ortho-mode transducer connected with the receive antenna, and said detecting includes detecting power from each of the split signals.

14. The method of claim 11, wherein the receive antennas are orthogonal mode antennas arranged to have 45-degree different polarization angles.

15. The method of claim 11, wherein the receive antennas are arranged to have polarization angles of 0, 45, 90, and 135 degrees, respectively.
